(19) United States
(12) Patent Application Publication
(10) Pub. No.: US 2016/0171213 A1
(43) Pub. Date: Jun. 16, 2016

(54) APPARATUS AND METHOD FOR CONTROLLING INSTRUCTION EXECUTION TO PREVENT ILLEGAL ACCESSES TO A COMPUTER

(71) Applicant: FUJITSU LIMITED, Kawasaki-shi (JP)

(72) Inventors: Kazuyoshi FURUKAWA, Kawasaki (JP); Hisashi Kojima, Yokosuka (JP); Masahiko TAKENAKA, Kawasaki (JP)

(21) Appl. No.: 14/881,464

(22) Filed: Oct. 13, 2015

(30) Foreign Application Priority Data
Dec. 12, 2014 (JP) 2014-251644

(51) Int. Cl. G06F 21/54

(52) U.S. Cl. CPC G06F 21/54; G06F 2221/033

(57) ABSTRACT

An apparatus stores first instructions including a call instruction and second instructions including a return instruction. When executing the second instructions called by the call instruction from the first instructions, the apparatus determines whether an instruction at a return address for return to the first instructions caused by the return instruction of the second instructions includes identification information. The apparatus continues processing of the first instructions when the instruction at the return address includes the identification information, and stops execution of the first instructions when the instruction at the return address does not include the identification information.

### CROSS-REFERENCE TO RELATED APPLICATION

This application is based upon and claims the benefit of priority of the prior Japanese Patent Application No. 2014-251644, filed on Dec. 12, 2014, the entire contents of which are incorporated herein by reference.

### FIELD

The embodiments discussed herein are related to apparatus and method for controlling instruction execution to prevent illegal accesses to a computer.

### BACKGROUND

With the development of the Internet, illegal access to computer systems is increasing. In order to prevent the illegal access, security features are provided.

Examples of the illegal access to computer systems include an attack technique in which, through a buffer overflow, malicious code is loaded into memory and execution of code is caused to transition to the malicious code. One of the security measures against this attack is a data execution prevention (DEP) feature. The DEP feature inhibits a program from being executed in a data memory area, thereby making it difficult to perform an attack through the buffer overflow.

There is a return-oriented programming (ROP) attack devised as an attack technique for avoiding the restrictions imposed by the DEP feature. The ROP attack is a programming technique in which information in a stack is tampered with by exploiting the vulnerability of a program, such as a stack overflow, and thus transition of execution of the program is controlled.

Examples of ROP attacks are described in Japanese Laid-open Patent Publication No. 2013-228957 and Japanese Laid-open Patent Publication No. 2011-008778.

### SUMMARY

According to an aspect of the invention, an apparatus stores first instructions including a call instruction and second instructions including a return instruction. When executing the second instructions called by the call instruction from the first instructions, the apparatus determines whether an instruction at a return address for return to the first instructions caused by the return instruction of the second instructions includes identification information. The apparatus continues processing of the first instructions when the instruction at the return address includes the identification information, and stops execution of the first instructions when the instruction at the return address does not include the identification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a ROP attack, according to an embodiment;

FIG. 2 is a diagram illustrating an example of correspondence between gadgets and a pseudo program in a ROP attack, according to an embodiment;

FIG. 3 is a diagram illustrating an example of assembly code with a return label field added, according to an embodiment;

FIG. 4 is a diagram illustrating an example of assembly code with a return label field added, according to an embodiment;

FIG. 5 is a diagram illustrating an example of a hardware configuration of an information processing device, according to an embodiment;

FIG. 6 is a diagram illustrating an example of an operational flowchart for an instruction execution control process of an information processing device, according to an embodiment;

FIG. 7 is a diagram illustrating an example of a process of an information processing device for a case where information in a stack area is not tampered with, according to an embodiment;

FIG. 8 is a diagram illustrating an example of a process of an information processing device for a case where information in a stack area is tampered with, according to an embodiment;

FIG. 9 is a diagram illustrating an example of a process of an information processing device for a case where information in a stack area is tampered with, according to an embodiment;

FIG. 10 is a diagram illustrating an example of assembly code, according to an embodiment; and

FIG. 11 is a diagram illustrating an example of a hardware configuration of an information processing device, according to an embodiment.

### DESCRIPTION OF EMBODIMENTS

The ROP attack tampers with information in a stack. With execution of code through the stack where tampering has occurred, the ROP attack implements processing equivalent to a pseudo program that the attacker wants to execute. The ROP attack allows the attacker to tamper with information in a stack and to thus execute an attack program in kernel space.

In one aspect, an object of the present disclosure is to provide an instruction execution control device and an instruction execution control method in which a ROP attack is detected, so that damage is avoided before the damage occurs.

Hereinafter, embodiments of the present disclosure will be described with reference to the accompanying drawings. However, the technical scope of the present disclosure is not limited to the embodiments and covers matters recited in the appended claims and equivalents thereof.

### First Embodiment

(ROP Attack)

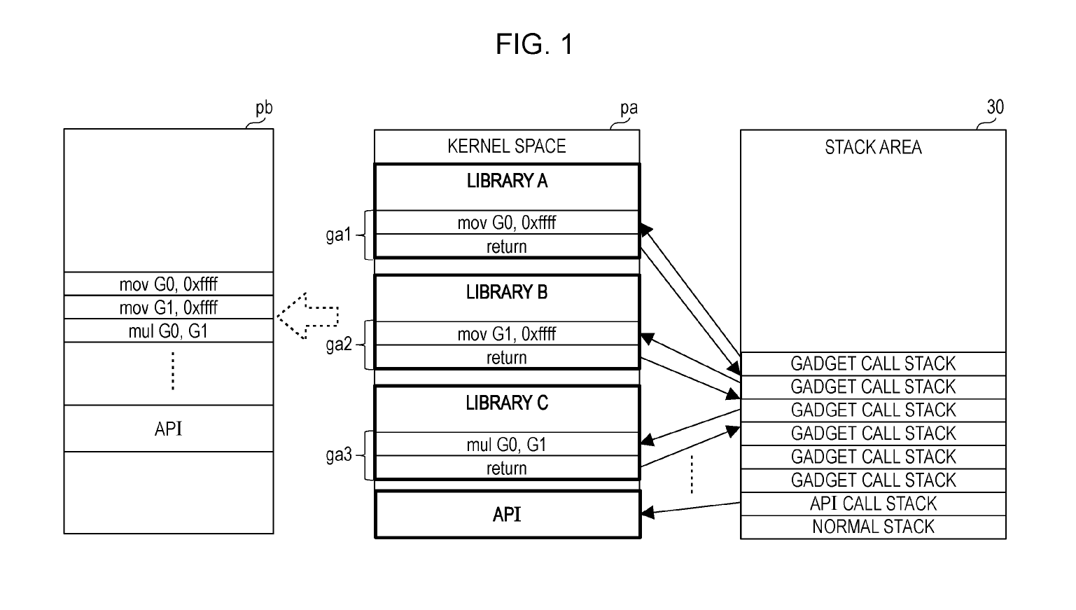

FIG. 1 is a diagram for explaining a ROP attack in the embodiment. The ROP attack is a programming technique in which, by exploiting the vulnerability of a program, such as a stack overflow, information in the stack is tampered with and thus the sequence of instructions to be executed is controlled.

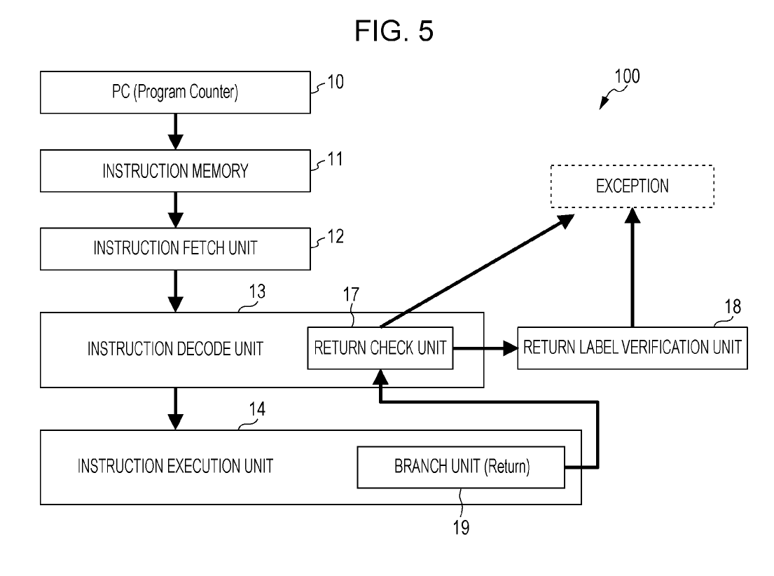

FIG. 1 illustrates a pseudo program pb that is executed in a pseudo manner by a ROP attack, a program pa in the kernel space in the memory area of an information processing device (a processor, an instruction execution control device), and a stack area 30 in the memory area. The configuration of the information processing device will be described below in conjunction with FIG. 5.

The program pa within the kernel space in the memory area (not illustrated) of the information processing device, illustrated in FIG. 1, represents a program that operates in the kernel space. The memory area includes the kernel space and user space (not illustrated).

The kernel space is a virtual memory area in which the program pa of the kernel of an operating system (OS) is stored. The kernel is software that implements fundamental functions of the OS. The program pa of the kernel includes, for example, library programs (hereinafter referred to as libraries) A to C and an application programming interface (API) illustrated in FIG. 1. In contrast, in the user space, applications of the user other than the kernel operate. The program pa, which operates in the kernel space, has privileges at a certain level or more. Consequently, a program (not illustrated) that operates in the user space is not capable of accessing the program pa that operates in the kernel space.

If an illegal program operates in the kernel space, a fault sometimes occurs in the information processing device itself. In contrast, even if an illegal program operates in the user space, the privileges of the program operating in the user space are low and thus has a small impact on the information processing device.

The stack area 30 illustrated in FIG. 1 is, for example, an area in which return addresses of programs are stacked. The return address represents the address of an instruction of a main routine to which, when a subroutine from the main routine is called, execution of code is to transition after processing of the subroutine has been completed. The information processing device, when processing a return instruction (return) of the subroutine, acquires, from the stack area 30, a return address for return to the main routine.

Note that information in the stack area 30 illustrated in FIG. 1 is tampered with. When information in the stack area 30 is not tampered with, a normal stack, illustrated in FIG. 1, is retained in the stack area 30. In contrast, in the stack area 30 where information is tampered with, call stacks for gadgets ga1 to ga3 and an API call stack are retained. The gadgets ga1 to ga3 (also referred to as gadgets ga) are a partial sequence of instructions of the libraries A to C and the API of the program pa and are a sequence of instructions for constituting the pseudo program pb. Each of the gadgets ga1 to ga3 is a sequence of instructions ending with a return instruction.

According to the example of FIG. 1, the gadget ga1 included in the library A of the program pa has an instruction “mov G0, 0xffff” and an instruction “return”. The gadget ga2 included in the library B of the program pa has an instruction “mov G1, 0xffff” and an instruction “return”. The gadget ga3 included in the library C of the program pa has an instruction “mul G0, G1” and an instruction “return”.

A ROP attacker tempers with information in the stack area 30 so that the stack area 30 contains the starting addresses (gadget call stacks) of the gadgets ga1 to ga3. For example, the ROP attacker tempers with information in the stack area 30 so that gadget call stacks are acquired in the order of the gadget ga1, the gadget ga2, and the gadget ga3. Thus, the ROP attacker may cause the information processing device to successively call and execute the gadgets ga1 to ga3.

Specifically, the information processing device, when processing a return instruction, reads the starting address of the gadget ga1 from the stack area 30 where information has been tempered with. The information processing device then processes the instruction “mov G0, 0xffff” and the instruction “return” of the gadget ga1. The information processing device, when processing the instruction “return” of the gadget ga1, also reads the starting address of the gadget ga2 from the stack area 30 and processes the instruction “mov G1, 0xffff” and the instruction “return” of the gadget ga2. Similarly, the information processing device, when processing the instruction “return” of the gadget ga2, reads the starting address of the gadget ga3 from the stack area 30 and processes the instruction “mul G0, G1” and the instruction “return” of the gadget ga3.

Thus, the ROP attacker may cause the information processing device to execute a sequence of instructions “mov G0, 0xffff; mov G1, 0xffff; mul G0, G1; . . . ” in the kernel space. In other words, the ROP attacker utilizes the gadgets ga1 to ga3 and the stack area 30 and thus may cause the information processing device to execute processing equivalent to the pseudo program pb illustrated in FIG. 1.

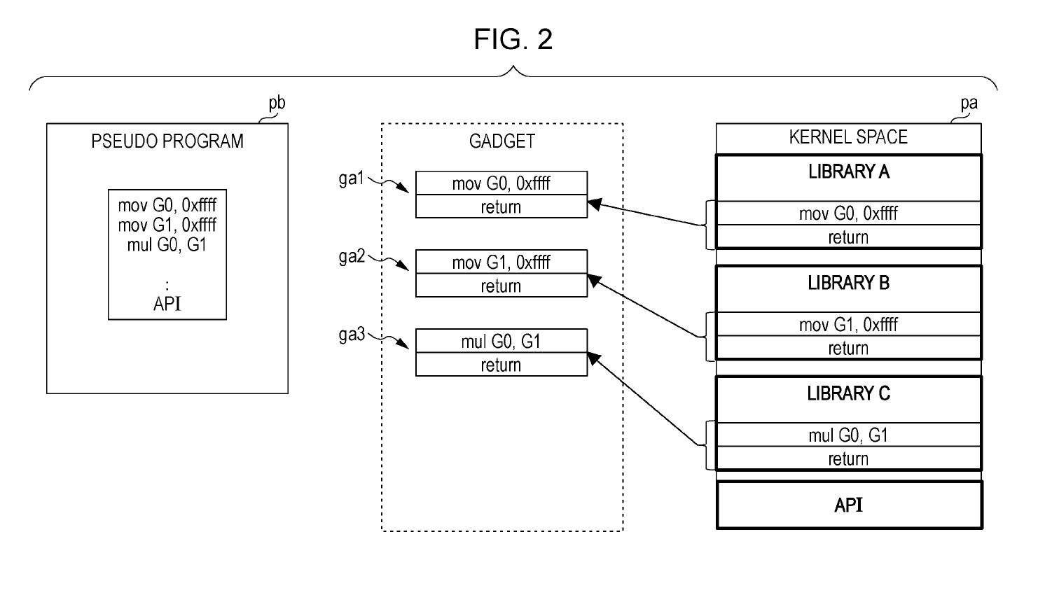

FIG. 2 is a diagram for explaining the correspondence between the gadgets ga1 to ga3 and the pseudo program pb in the ROP attack explained with reference to FIG. 1. In FIG. 2, the same components as those illustrated in FIG. 1 are denoted by the same reference characters.

As described above with reference to FIG. 1, each of the gadgets ga1 to ga3 is a sequence of instructions ending with a return instruction in the program pa. As illustrated in FIG. 2, each of the gadgets ga1 to ga3 as a single item does not include many instructions. However, the ROP attacker may implement processing equivalent to the pseudo program pb in a pseudo manner by combining a plurality of gadgets ga1 to ga3.

The ROP attacker exploits, as the gadgets ga1 to ga3, a partial sequence of instructions of the program pa that operates in the kernel space. Thus, the ROP attacker may execute an arbitrary program in the kernel space in accordance with the elevated privileges. Accordingly, it is possible, for example, to damage the kernel through a ROP attack.

(Outline of Present Embodiment)

As illustrated in FIG. 1 and FIG. 2, in a ROP attack, execution of instructions transitions to an instruction at a middle point in the program pa to which processing is normally not returned from a subroutine. Accordingly, the information processing device in the embodiment detects a ROP attack by using the characteristics of a ROP attack in which execution of instructions transitions to an instruction different from the instruction indicated by the return address for return from a subroutine call. That is, the information processing device detects a ROP attack when the instruction to which execution of instructions has transitioned under a return instruction is not an instruction at the return address.

Specifically, in the embodiment, in a sequence of instructions, an instruction at the return address from a subroutine has a return label (identification information) indicating the address of an instruction to which processing is to return. The information processing device, when executing a second routine (instructions) called by a call instruction of a first routine (instructions), determines whether or not an instruction at a return address for return to the first routine caused by a return instruction of the second routine has a return label. The information processing device continues processing of the first routine when the instruction at the return address has a return label, and stops execution of instructions when the instruction does not have a return label.

When the instruction at the return address does not have a return label, this indicates transition to an illegal address and indicates that information in the stack area 30 is tempered with. Accordingly, the information processing device stops execution of instructions. In this way, the information processing device detects a ROP attack by detecting transition to an illegal address, which is different from a normal return address, from a subroutine and thus inhibits damage caused by the ROP attack before the damage occurs.

As described above, the information processing device stops execution of instructions when the instruction at the return address does not have a return label. This means that, when a ROP attacker tampers with information in the stack area 30 so that the instruction at the return address has a return label, the information processing device does not stop execution of instructions.

However, among sequences of instructions included in the program pa in the kernel space, there are few sequences of instructions in which an instruction with a return label is included and an instruction that a ROP attacker wants to use is included. More specifically, there are few sequences of instructions in which an instruction that begins with an instruction with a return label, that a ROP attacker wants to use, and that ends with a return instruction is included. That is, the restriction of a return label significantly limits sequences of instructions usable as the gadgets ga.

Thus, based on the limited gadgets ga, it becomes more difficult to arbitrarily compose the pseudo program pb desired to be executed by the information processing device. Accordingly, the information processing device of the embodiment may reduce the ease with which a ROP attack is performed, by imposing restrictions to sequences of instructions usable as the gadgets ga, as well as detecting a ROP attack and inhibiting damage caused by the ROP attack before the damage occurs.

(Assembly Code)

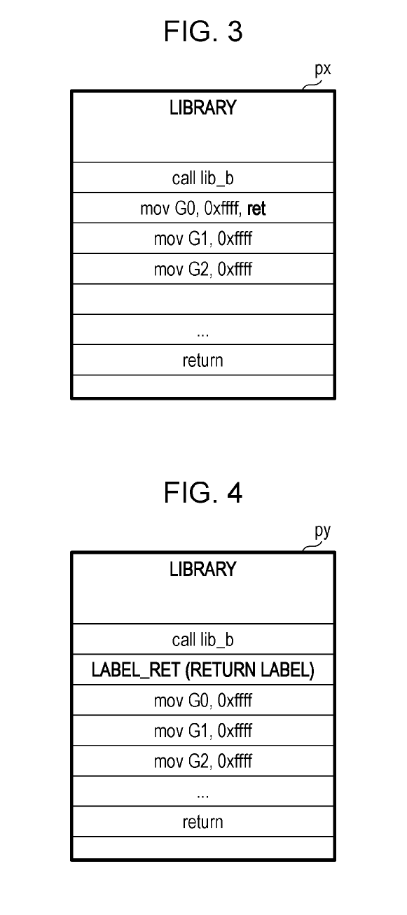

As examples of the program pa in the first embodiment, examples of assembly code will be described in conjunction with FIG. 3 and FIG. 4. The assembly code depicted in FIG. 3 and FIG. 4 is examples of the program pa illustrated in FIG. 1 and FIG. 2 and is programs written in an assembly language. The assembly code depicted in FIG. 3 and the assembly code depicted in FIG. 4 differ in the form of addition of a return label.

FIG. 3 is a diagram depicting an example of assembly code px, with a return label field added, in the first embodiment. The assembly code px depicted in FIG. 3 has an instruction 1 “call lib_b”, an instruction 2 “mov G0, 0xffff, ret”, an instruction 3 “mov G1, 0xffff”, an instruction 4 “mov G2, 0xffff”, an instruction “ . . . ”, and an instruction n “return”.

Each instruction in binary code generated by assembling the assembly code px depicted in FIG. 3 has a field of a return label. The return label field is a field for adding a return label. The third area (the area of “ret”) in the instruction 2 “mov G0, 0xffff, ret” represents a return label field. The value “ret” of the instruction 2 represents the value of a return label. The creator of the program adds the value “ret” representing a return label in the return label field of the instruction 2 at the return address of the instruction 1 “call lib_b” that calls a subroutine.

Accordingly, in the example depicted in FIG. 3, based on whether or not a return label is added to an instruction at a return address, the information processing device determines whether or not the instruction at the return address has a return label.

A compiler generates the assembly code px depicted in FIG. 3 and further assembles it, thereby generating binary code executable by the information processing device. At this point, the compiler adds just return label fields to the instruction 1 and the instructions 3 to n other than the instruction 2. Consequently, the return label fields of the instruction 1 and the instructions 3 to n other than the instruction 2 in binary code do not have values of return labels. In contrast, the return label field of the instruction 2 in binary code has, for example, a return label value of 1 bit.

In such a manner, for example, the compiler adds a return label field to each instruction. As a result, the creator of a program does not have to add fields for return labels to all instructions except the instruction 2 of the assembly code px in order to add return labels. Accordingly, it becomes easy to add return labels to the program (the assembly code px).

Alternatively, the compiler, when compiling, detects the instruction 2, which is at the return address of the instruction 1 “call lib_b” that calls a subroutine, and may add “return label (ret)” to the instruction 2. In such a manner, the compiler detects an instruction indicated by the return address of an instruction that calls a subroutine. Thereby, it becomes easier to add return labels to the program.

FIG. 4 is a diagram depicting an example of assembly code py, with a return label added, in the first embodiment. Different from the assembly code px depicted in FIG. 3, the assembly code py depicted in FIG. 4 has an instruction “LABEL_RET (RETURN LABEL)” at the return address.

The assembly code py depicted in FIG. 4 has an instruction 11 “call lib_b”, an instruction 12 “LABEL_RET (RETURN LABEL)”, an instruction 13 “mov G0, 0xffff, ret”, an instruction 14 “mov G1, 0xffff”, an instruction 15 “mov G2, 0xffff”, an instruction “ . . . ”, and an instruction in “return”. The instruction 12 “LABEL_RET (RETURN LABEL)” has, for example, a value of 1 bit and is an instruction that will not be executed.

The creator of the program adds an instruction (label) “LABEL_RET” to a return address of the instruction 11 “call lib_b” that calls a subroutine. Consequently, in the example of FIG. 4, based on whether or not the instruction at the return address is a return label, the information processing device determines whether or not the instruction at the return address has a return label.

The compiler generates the assembly code py depicted in FIG. 4 and further assembles it, thereby generating binary code executable by the information processing device. Note that the compiler may detect the return address of the instruction 11 “call lib_b”, which calls a subroutine, and add a return label. The compiler detects the return address of an instruction, which calls a subroutine, and adds a return label, thereby making it easier to add a return label to the program.

Note that, in the example depicted in FIG. 4, the assembly code py may have a given instruction such as a NOP instruction instead of the return label. Like for the return label, the information processing device will not execute the given instruction.

Note that the amount in an increase in program code caused by the addition of the return label fields or the return label (the given instruction) to the assembly code px depicted in FIG. 3 or the assembly code py depicted in FIG. 4 is about 5%. Accordingly, the amount in an increase in the program code caused by the addition of the return label fields or the return label (the given instruction) is not large.

Note that although programs in assembly code are exemplified in FIG. 3 and FIG. 4, programs to which return labels are to be added are not limited to programs in assembly code.

(Hardware Configuration of Information Processing Device)

FIG. 5 is a diagram illustrating a hardware configuration of the information processing device in the first embodiment. An information processing device 100 illustrated in FIG. 5 includes, for example, a program counter (PC) 10, an instruction memory 11, an instruction fetch unit 12, an instruction decode unit 13, an instruction execution unit 14, and so on.

The program counter 10 is a register that stores the address of an instruction to be executed next. The instruction memory 11 is an area in which instructions processed by the information processing device 100 are stored. The instruction memory 11 is, for example, static random access memory (SRAM). The instruction fetch unit 12, based on the value of the program counter 10, reads an instruction from the instruction memory 11 and outputs the instruction to the instruction decode unit 13. The instruction decode unit 13 decodes the instruction acquired by the instruction fetch unit 12 and outputs the instruction to the instruction execution unit 14.

The instruction execution unit 14 includes a computing unit (not illustrated) and a branch unit 19. The computing unit performs, for example, computations including arithmetic operations, such as addition and subtraction, and logical operations and writes computation results to a register (not illustrated) or the like. The branch unit 19, for example, when performing a branch caused by a return instruction, takes out a return address from the stack area (FIG. 1) 30 and sets the return address to the program counter 10. Note that although the stack area 30 is not illustrated in FIG. 5, the stack area 30 is included, for example, in the main memory (not illustrated), or cache memory (not illustrated) of the information processing device 100. The branch unit 19 is coupled to the main memory and the cache memory.

The instruction decode unit 13 in the embodiment includes a return check unit 17. The information processing device 100 in the embodiment further includes a return label verification unit 18.

The branch unit 19, when performing a branch caused by a return instruction, enables the return check unit 17. When enabled, the return check unit 17 determines whether or not an instruction decoded by the instruction decode unit 13 has a return label, and disables the return check unit 17 itself. When the instruction has a return label, the return check unit 17 outputs the return label to the return label verification unit 18. On the other hand, when the instruction does not have a return label, the return check unit 17 causes an exception to occur.

The return check unit 17 includes, for example, an AND circuit (not illustrated). The AND circuit receives a signal indicating the value of a return label and a signal indicating whether the return check unit 17 is enabled or disabled. When the return check unit 17 is enabled and the value of a return label is present, the AND circuit outputs the value of the return label.

The return label verification unit 18 verifies whether or not a return label has a proper value. When the return label does not have a proper value, the return label verification unit 18 causes an exception to occur. The return label verification unit 18 includes, for example, a comparator (not illustrated). The comparator compares the value of a return label output by the return check unit 17 with the proper value for a return label and output a comparison result.

(Flow of Instruction Execution Control Process)

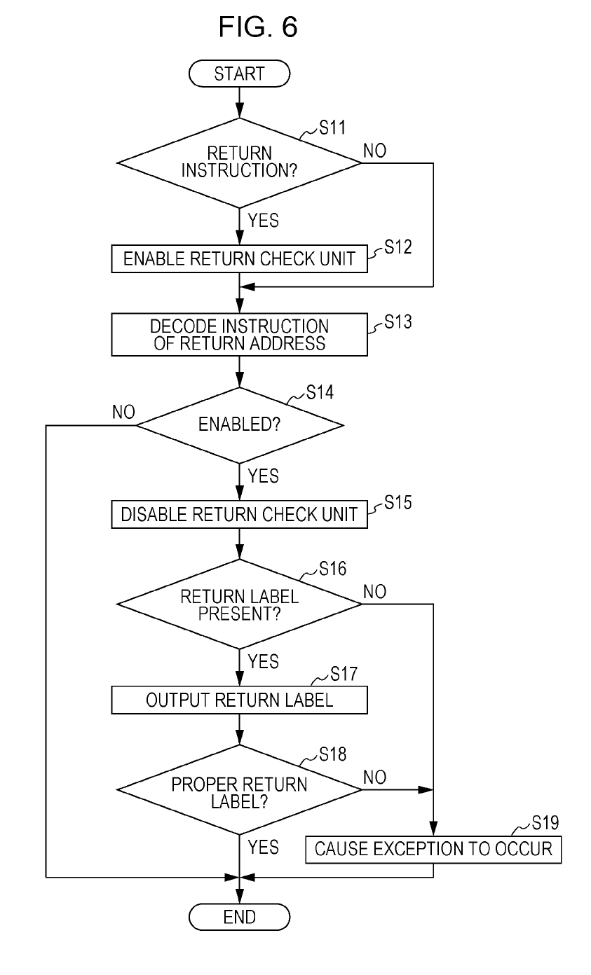

FIG. 6 is a diagram illustrating an example of an operational flowchart for an instruction execution control process of the information processing device 100 illustrated in FIG. 5.

S11: The instruction execution unit 14 determines whether or not an instruction to be executed is a return instruction.

S12: When a return instruction is to be executed (Yes in S11), the branch unit 19 of the instruction execution unit 14 acquires the return address of the return instruction from the stack area 30 and sets the return address to the program counter 10. The branch unit 19 enables the return check unit 17.

S13: The instruction fetch unit 12 reads, from the instruction memory 11, an instruction indicated by the program counter 10 and outputs the instruction to the instruction decode unit 13. The instruction decode unit 13 decodes the instruction acquired by the instruction fetch unit 12.

S14: The instruction decode unit 13 determines whether or not the return check unit 17 is enabled. Note that when the return check unit 17 is disabled (No in S14), the instruction decode unit 13 outputs the decoded instruction to the instruction execution unit 14.

S15: On the other hand, when the return check unit 17 is enabled (Yes in S14), the instruction decode unit 13 disables the return check unit 17.

S16: After step S15, the return check unit 17 determines whether or not the instruction decoded in step S13 has a return label.

S17: When the instruction has a return label (Yes in S16), the return check unit 17 outputs the return label to the return label verification unit 18.

S18: The return label verification unit 18 determines whether or not the return label output by the return check unit 17 is predetermined information. That is, the return label verification unit 18 determines whether or not the return label has a proper value. Determining whether or not the return label is the predetermined information allows the determination of whether or not the return address has a proper value to be performed more strictly.

For example, the return label verification unit 18 compares the return label output by the return check unit 17 with the predetermined information and, based on whether or not the return label matches the predetermined information, determines whether or not the return label is proper. When the return label is proper (Yes in S18), the instruction decode unit 13 outputs the decoded instruction to the instruction execution unit 14.

S19: On the other hand, when the instruction does not have a return label (No in S16), the return check unit 17 causes an exception to occur. Also, when the return label is an illegal label (No in S18), the instruction decode unit 13 causes an exception to occur.

(In Case where Information in Stack Area is not Tampered with)

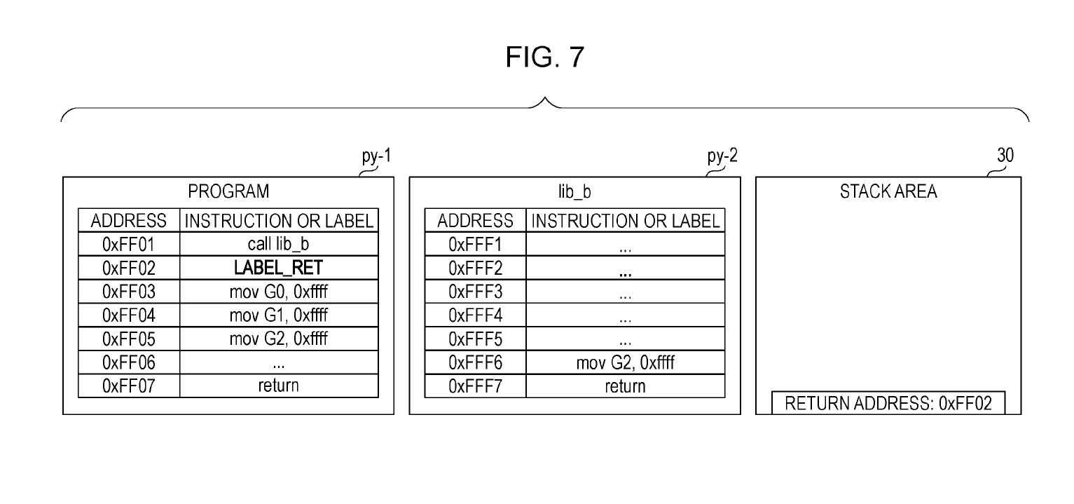

FIG. 7 is a diagram for explaining the process of the information processing device 100 illustrated in FIG. 5, based on the case where information in the stack area 30 illustrated in FIG. 1 is not tampered with. In FIG. 7, the same components as those illustrated in FIG. 1 are denoted by the same reference characters. FIG. 7 illustrates a program py-1, a library “lib_b” py-2 called by the program py-1, and the stack area 30. The program py-1 and the library “lib_b” py-2 are programs that operate in the kernel space.

The program py-1 illustrated in FIG. 7 includes instructions 31 to 37. The instruction 31 indicated by an address “0xFF01” is an instruction “call lib_b”. The instruction 32 indicated by an address “0xFF02” is an instruction (label) “LABEL_RET (RETURN LABEL)”. The instruction 33 indicated by an address “0xFF03” is an instruction “mov G0, 0xffff”. The instruction 34 indicated by an address “0xFF04” is an instruction “mov G1, 0xffff”. The instruction 35 indicated by an address “0xFF05” is an instruction “mov G2, 0xffff”. The instruction 37 indicated by an address “0xFF07” is an instruction “return”.

In other words, the program py-1 illustrated in FIG. 7 is a program that, after calling the library “lib_b” py-2, sequentially moves values retained in registers G0 to G2.

When calling the instruction 31 “call lib_b”, the instruction execution unit 14 adds the return address “0xFF02” to the stack area 30. Then, the instruction execution unit 14 sequentially executes instructions of the library “lib_b” py-2 and processes a return instruction at the bottom indicated by the address “0xFFF7” (Yes in S11 in FIG. 6). At this point, the branch unit 19 acquires the return address “0xFF02” from the stack area 30, sets this return address to the program counter 10, and enables the return check unit 17 (S12).

The instruction fetch unit 12 acquires the instruction (label) “LABEL_RET (RETURN LABEL)” indicated by the program counter 10 and outputs this instruction to the instruction decode unit 13. The instruction decode unit 13 decodes the instruction (label) “LABEL_RET” (S13) and determines whether or not the return check unit 17 is enabled (S14).

Through step S12, the return check unit 17 is enabled (Yes in S14). Consequently, the instruction decode unit 13 disables the return check unit 17 (S15) and determines whether or not the instruction (label) “LABEL_RET” has a return label (S16). The instruction (label) “LABEL_RET” is a return label (Yes in S16), and therefore the return label verification unit 18 determines whether or not the return label has a proper value (S17, S18).

The return label verification unit 18 determines whether or not the instruction (label) “LABEL_RET” matches a proper label “LABEL_RET”. The instruction (label) “LABEL_RET” illustrated in the example of FIG. 7 has a proper value (Yes in S18), and therefore the instruction decode unit 13 does not cause an exception to occur. Note that the instruction execution unit 14 does not execute the instruction (label) “LABEL_RET”.

Next, the instruction fetch unit 12 acquires the instruction “mov G0, 0xffff” at the address “0xFF03” indicated by the incremented program counter 10. The instruction decode unit 13 decodes the instruction “mov G0, 0xffff” (S13) and determines whether or not the return check unit 17 is enabled (S14). Since the previously processed instruction is not a return instruction, the return check unit 17 is not enabled (No in S14). Consequently, the instruction decode unit 13 outputs the decoded instruction to the instruction execution unit 14.

(In Case where Information in Stack Area is Tampered with)

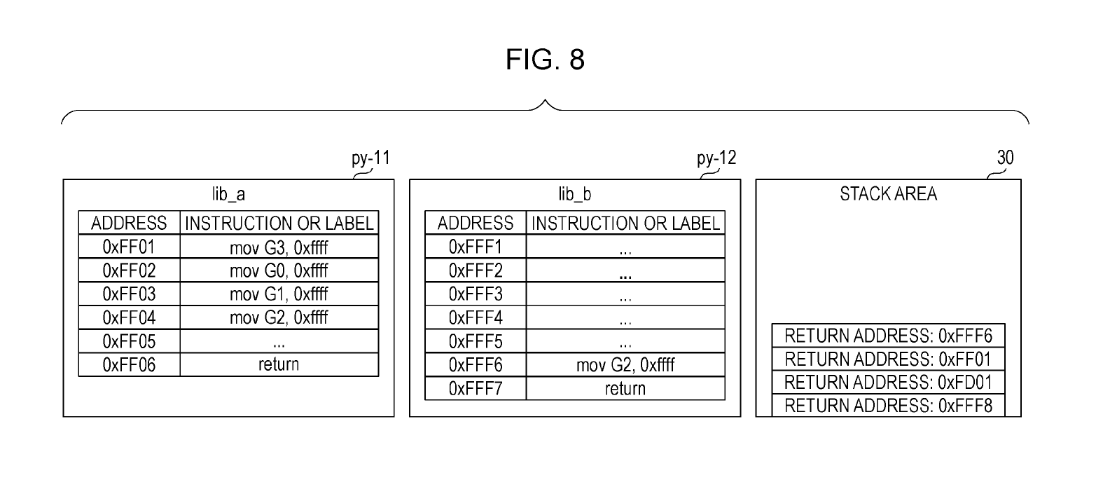

FIG. 8 is a diagram (1) for explaining the process of the information processing device 100 illustrated in FIG. 5, based on the case where information in the stack area 30 illustrated in FIG. 1 is tampered with. In FIG. 8, the same components as those illustrated in FIG. 1 are denoted by the same reference characters. FIG. 8 illustrates a library “lib_a” py-11, a library “lib_b” py-12, and the stack area 30. The library “lib_a” py-11 and the library “lib_b” py-12 are programs that operate in the kernel space.

The library “lib_a” py-11 illustrated in FIG. 8 includes instructions 41 to 46. The instruction 41 indicated by the address “0xFF01” is an instruction “mov G3, 0xffff”. The instruction 42 indicated by the address “0xFF02” is the instruction “mov G0, 0xffff”. The instruction 43 indicated by the address “0xFF03” is the instruction “mov G1, 0xffff”. The instruction 44 indicated by the address “0xFF04” is the instruction “mov G2, 0xffff”. The instruction 46 indicated by the address “0xFF06” is the instruction “return”.

In other words, the library “lib_a” py-11 illustrated in FIG. 8 is a program that, after moving a value retained in a register G3, sequentially moves values retained in the registers G0 to G2. Information in the stack area 30 illustrated in FIG. 8 is tampered with by an attacker, and the stack area 30 contains return addresses “0xFFF6”, “0xFF01”, “0xFD01”, and “0xFFF8” in the order in which they are taken out.

Once a return instruction (not illustrated) is detected (Yes in S11 in FIG. 6), the branch unit 19 acquires the return address “0xFFF6” from the stack area 30, sets this return address to the program counter 10, and enables the return check unit 17 (S12). The return address “0xFFF6” is an address that has been tempered with, and indicates the instruction “mov G2, 0xffff” in the library “lib_b” py-12.

Next, the instruction fetch unit 12 acquires the instruction “mov G2, 0xffff” and outputs it to the instruction decode unit 13. The instruction decode unit 13 decodes the instruction “mov G2, 0xffff” (S13) and determines whether or not the return check unit 17 is enabled (S14).

Through step S12, the return check unit 17 is enabled (Yes in S14). Consequently, the instruction decode unit 13 disables the return check unit 17 (S15) and determines whether or not the acquired instruction “mov G2, 0xffff” has a return label (S16). The instruction “mov G2, 0xffff” does not have a return label (No in S16), and therefore the return check unit 17 causes an exception to occur (S19).

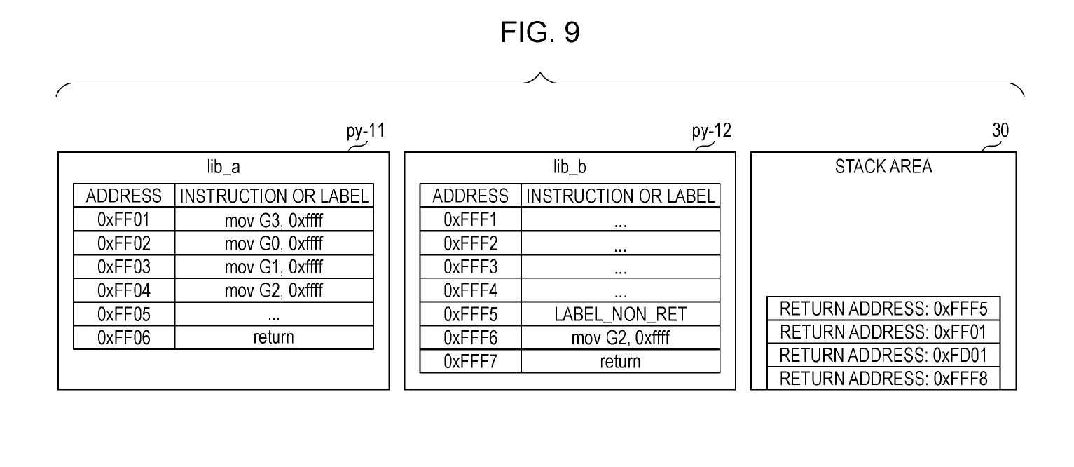

FIG. 9 is a diagram (2) for explaining the process of the information processing device 100 illustrated in FIG. 5, based on the case where information in the stack area 30 illustrated in FIG. 1 is tampered with. In FIG. 9, the same components as those illustrated in FIG. 1 are denoted by the same reference characters.

The library “lib_a” py-11 and the library “lib_b” py-12 illustrated in FIG. 9 are the same as those in FIG. 8. However, although not illustrated in FIG. 8, the library “lib_b” py-12 includes an instruction (label) “LABEL_NON_RET” at the address “0xFFF5”. The instruction (label) “LABEL_NON_RET” is an improper label. The stack area 30 illustrated in FIG. 9 differs from the stack area 30 illustrated in FIG. 8. Information in the stack area 30 illustrated in FIG. 9 is tempered with by an attacker and the stack area 30 contains the return addresses “0xFFF5”, “0xFF01”, “0xFD01”, and “0xFFF8” in the order in which they are taken out.

Once a return instruction (not illustrated) is detected (Yes in S11 in FIG. 6), the branch unit 19 acquires the return address “0xFFF5” from the stack area 30, sets this return address to the program counter 10, and enables the return check unit 17 (S12). The return address “0xFFF5” is an address that has been tampered with, and indicates the instruction (label) “LABEL_NON_RET” in the library “lib_b” py-12.

Next, the instruction fetch unit 12 acquires the instruction (label) “LABEL_NON_RET” and outputs it to the instruction decode unit 13. The instruction decode unit 13 decodes the instruction (label) “LABEL_NON_RET” (S13) and determines whether or not the return check unit 17 is enabled (S14).

Through step S12, the return check unit 17 is enabled (Yes in S14). Consequently, the instruction decode unit 13 disables the return check unit 17 (S15) and determines whether or not the acquired instruction (label) “LABEL_NON_RET” has a return label (S16). In the example of FIG. 9, since the acquired instruction (label) “LABEL_NON_RET” has a return label (Yes in S16), the return label verification unit 18 determines whether or not the acquired instruction (label) “LABEL_NON_RET” matches the proper label “LABEL_RET” (S17, S18). The acquired instruction (label) “LABEL_NON_RET” does not match the proper label (No in S18), and therefore the return label verification unit 18 causes an exception to occur (S19).

As illustrated in FIG. 7 to FIG. 9, the information processing device 100 in the first embodiment may detect a ROP attack by determining the return address of a return instruction. Then, the information processing device 100, upon detecting a ROP attack, causes an exception to occur and thus may stop execution of instructions. According to the first embodiment, there are very few changes in hardware made to the information processing device 100. Accordingly, few changes in hardware make it possible to efficiently detect a ROP attack and avoid the ROP attack.

As described above, the information processing device 100 in the first embodiment may significantly limit sequences of instructions usable as the gadgets ga by an attacker. Accordingly, if a ROP attacker detects the configuration of the information processing device 100 illustrated in FIG. 5, it is possible to limit sequences of instructions used as the gadgets by the attacker. In other words, even if the attacker detects the configuration of the information processing device 100 in the embodiment, there are few sequences of instructions usable as the gadgets ga.

Accordingly, according to the embodiment, even when the configuration of the information processing device 100 is detected by an attacker, it is possible to make it difficult to compose a desirable program based on the gadgets ga and to reduce the ease with which a ROP attack is performed. Thus, it becomes possible to suppress ROP attacks.

### Second Embodiment

In a second embodiment, in addition to the first embodiment, limitations are provided to programs for which an information processing device detects a ROP attack. In the second embodiment, each of the assembly code px and py depicted in FIG. 3 and FIG. 4 has a verification return-instruction “return_verify” instead of the return instruction “return”. The information processing device in the second embodiment, upon detecting a verification return-instruction, performs a process of determining a return address.

More specifically, an information processing device 200 in the second embodiment, when processing a return instruction, determines whether or not the return instruction is the verification return-instruction “return_verify”. When the return instruction is the verification return-instruction, the information processing device 200, as described in the first embodiment, determines whether or not an instruction at the return address has a return label.

On the other hand, when the return instruction is not the verification return-instruction, the information processing device 200 continues processing in a routine to which the information processing device 200 returns to, without determining whether or not an instruction at the return address has a return label.

Thus, the information processing device in the second embodiment may cause a certain program to be out of the scope of detection of a ROP attack. In other words, it becomes possible to omit processing of detecting a ROP attack for a certain program. Thus, it becomes possible to omit addition of a return label to the certain program that is out of the scope of detection processing.

As described with reference to FIG. 1 and FIG. 2, a ROP attacker utilizes the gadgets ga based on the program pa that operates in the kernel space. Thus, the attacker causes processing similar to the pseudo program pb (FIG. 1, FIG. 2) to be executed in accordance with the elevated privileges in the kernel space so as to destroy the kernel. In contrast, a program that operates in the user space is less prone to being used as the gadget ga. Accordingly, the information processing device may omit processing of detecting a ROP attack on a program that operates in the user space.

(Assembly Code)

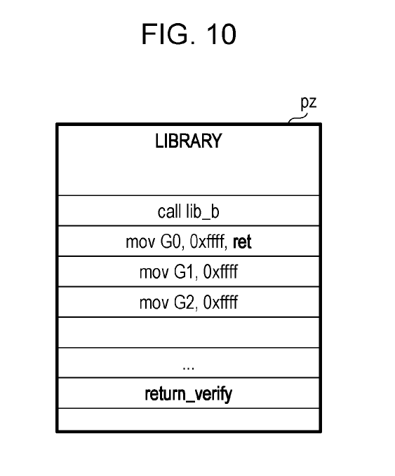

FIG. 10 is a diagram depicting an example of assembly code pz in the second embodiment. The assembly code pz depicted in FIG. 10 is an example of the program pa illustrated in FIG. 1 and FIG. 2 and is a program written in an assembly language. The assembly code pz depicted in FIG. 10 corresponds to the assembly code px depicted in FIG. 3.

The assembly code pz depicted in FIG. 10 has an instruction 51 “call lib_b”, an instruction 52 “mov G0, 0xffff, ret”, an instruction 53 “mov G1, 0xffff”, an instruction 54 “mov G2, 0xffff”, an instruction “ . . . ”, and an instruction 5n “return_verify”. The value “ret” in the instruction 52 “mov G0, 0xffff, ret” is a return label. The instruction “return_verify” indicated in the instruction 5n “return_verify” is a verification return-instruction.

The assembly code pz depicted in FIG. 10 has the verification return-instruction “return_verify”. Consequently, the assembly code pz is a program for which detection of a ROP attack is carried out, and is the program pa (FIG. 1) that operates in the kernel space. In the example of the second embodiment, a program that operates in the user space does not have the verification return-instruction “return_verify” and a return label.

(Hardware Configuration of Information Processing Device)

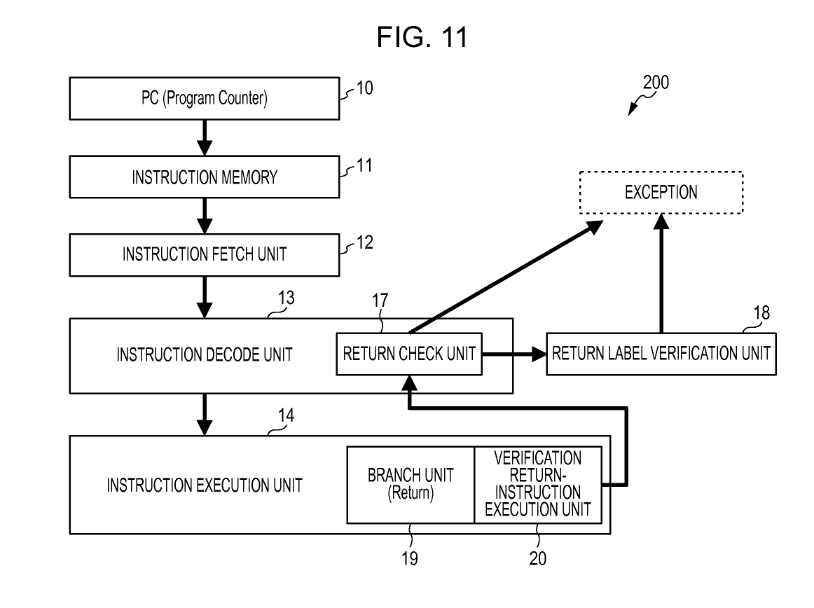

FIG. 11 is a diagram illustrating a hardware configuration of the information processing device in the second embodiment. In FIG. 11, the same components as those illustrated in FIG. 5 are denoted by the same reference characters. The information processing device 200 illustrated in FIG. 11, like the information processing device 100 illustrated in FIG. 5, includes the program counter 10, the instruction memory 11, the instruction fetch unit 12, the instruction decode unit 13, the instruction execution unit 14, and so on.

The information processing device 200 in the second embodiment differs in the instruction execution unit 14 from the information processing device 100 in the first embodiment. The instruction execution unit 14 in the second embodiment further includes a verification return-instruction execution unit 20. The verification return-instruction execution unit 20 determines whether or not a return instruction to be processed is the verification return-instruction “return_verify”. When the return instruction is the verification return-instruction “return_verify”, the verification return-instruction execution unit 20 enables the return check unit 17. The branch unit 19 takes out a return address from the stack area (FIG. 1) 30 and sets the return address to the program counter 10. The subsequent processing is as described with reference to the flowchart in FIG. 6 in the first embodiment.

On the other hand, when the return instruction is a normal return instruction “return”, the verification return-instruction execution unit 20 does not enable the return check unit 17 even when a branch caused by the return instruction is performed. The branch unit 19 of the instruction execution unit 14, when performing a branch caused by a return instruction, takes out a return address from the stack area (FIG. 1) 30 and sets the return address to the program counter 10. The verification return-instruction execution unit 20 inhibits the branch unit 19 from enabling the return check unit 17.

Next, the instruction fetch unit 12 reads an instruction indicated by the program counter 10 from the instruction memory 11, and the instruction decode unit 13 decodes the instruction acquired by the instruction fetch unit 12 (S13 in FIG. 6). The return check unit 17 is disabled (No in S14), and therefore the instruction decode unit 13 outputs the decoded instruction to the instruction execution unit 14.

As illustrated in FIG. 10 and FIG. 11, the information processing device 200 in the second embodiment provides the verification return-instruction “return_verify” and thus may cause some of the programs to be out of the scope of detection of a ROP attack.

Programs that operate in user space may be created by various creators. Accordingly, it is not easy to demand that all the creators add return labels to the programs. Programs that operate in user space may also be generated by various compilers. It is also not easy to add, to all the compilers, a feature of adding a field of a return label depicted in FIG. 3.

In such a manner, it is not easy to add return labels to all the programs that operate in user space. When the information processing device 100 executes a program with no return label, an exception will occur during execution of a return instruction.

Accordingly, in the second embodiment, a ROP attack is detected only for programs that operate in kernel space. That is, in the second embodiment, the program to which a return label is added is limited to the program pa (FIG. 1) that operates in the kernel space. This minimizes the range of changes made to programs, and therefore it is possible to more efficiently detect a ROP attack. It is also possible to reduce the load on the user caused by applying the instruction execution control method in the embodiment.

Note that FIG. 10 exemplifies the case where the verification return-instruction is the instruction “return_verify”. However, the verification return-instruction is not limited to this example. The verification return-instruction may be in the form in which a predetermined parameter is added to a normal return instruction “return”.

### Another Embodiment

In the first embodiment, the case where the return label has a predetermined value (“LABEL_RET”) is exemplified. However, return labels may have different values in accordance with the types of subroutines called by the main routine. For example, the return labels of the assembly code px and the assembly code py depicted in FIG. 3 and FIG. 4 have different values in accordance with subroutines called by call instructions.

Accordingly, the return label verification unit 18 determines, for example, whether or not a return label (the value in accordance with a subroutine called by a call instruction) matches a label value in accordance with a subroutine including a return instruction (S18 in FIG. 6).

When there is a match (Yes in S18), this indicates that the subroutine called by the call instruction matches the subroutine including the return instruction, and indicates that transition between routines is proper. The case where transition between routines is proper indicates that information in the stack area 30 is not tampered with, and therefore the instruction decode unit 13 outputs a decoded instruction to the instruction execution unit 14.

On the other hand, when there is no match (No in S18), this indicates that the subroutine called by the call instruction and the subroutine including the return instruction are different, and indicates that transition between routines are improper. The case where transition between routines is improper indicates that information in the stack area 30 is tampered with, and therefore the return label verification unit 18 causes an exception to occur.

In such a manner, according to another embodiment, it is possible to determine based on the value of a return label whether or not transition between routines is proper. This makes it possible to detect tempering in the stack area 30. Accordingly, even if a ROP attacker detects the configuration of the information processing device 100 or 200 in the first or second embodiment, the ease with which a ROP attack is performed may be reduced more. Thus, it becomes possible to suppress ROP attacks.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An instruction execution control device comprising:
a memory configured to store first instructions including a call instruction and second instructions including a return instruction; and
a processor configured:
to, when executing the second instructions called by the call instruction from the first instructions, determine whether an instruction at a return address for return to the first instructions caused by the return instruction of the second instructions includes identification information, and
to continue processing of the first instructions when the instruction at the return address includes the identification information, and stop execution of instructions when the instruction at the return address does not include the identification information.

2. The instruction execution control device of claim 1, wherein,
based on whether the identification information is added to the instruction at the return address, the processor determines whether the instruction at the return address includes the identification information.

3. The instruction execution control device of claim 1, wherein,
based on whether the instruction at the return address is the identification information, the processor determines whether the instruction at the return address includes the identification information.

4. The instruction execution control device of claim 1, wherein,
when the instruction at the return address includes the identification information, the processor further determines whether the identification information is predetermined information; and
the processor continues processing of the first instructions when the identification information is the predetermined information, and stops the processing of the first instructions when the identification information is not the predetermined information.

5. The instruction execution control device of claim 1, wherein
the processor further determines whether the return instruction of the second instructions is a verification return-instruction for verifying the return address;
when the return instruction of the second instructions is the verification return-instruction, the processor determines whether the instruction at the return address includes the identification information; and
when the return instruction of the second instructions is not the verification return-instruction, the processor continues processing of the first instructions without determining whether the instruction at the return address includes the identification information.

6. The instruction execution control device of claim 1, wherein,
when the instruction at the return address does not include the identification information, the processor causes an exception to occur.

7. The instruction execution control device of claim 1, wherein
the memory includes a stack area for storing return addresses to which execution of code is to transition when return instructions are executed; and
the processor acquires, from the stack area, the return address for return to the first instructions caused by the return instruction of the second instructions, and determines whether an instruction at the return address includes the identification information.

8. The instruction execution control device of claim 1, wherein
the processor includes an instruction decode unit that includes a determination unit and decodes instructions, and an instruction execution unit that includes a branch unit and executes instructions;
when the return instruction of the second instructions is executed by the instruction execution unit, the branch unit instructs the determination unit to perform a determination of the instruction at the return address; and
the determination unit determines whether the instruction at the return address decoded by the instruction decode unit includes the identification information.

9. An instruction execution control method comprising:
when executing second instructions, including a return instruction, called by a call instruction of first instructions, determining whether an instruction at a return address for return to the first instructions caused by the return instruction of the second instructions includes identification information; and
continuing processing of the first instructions when the instruction at the return address includes the identification information, and stopping execution of instructions when the instruction at the return address does not include the identification information.

10. The instruction execution control method of claim 9, wherein,
the determining whether the instruction at the return address includes the identification information is performed based on whether the identification information is added to the instruction at the return address.

11. The instruction execution control method of claim 9, wherein,
the determining whether the information at the return address includes the identification information is performed based on whether the instruction at the return address is the identification information.

12. The instruction execution control method of claim 9, wherein,
the determining further includes determining whether the identification information is predetermined information when the instruction at the return address includes the identification information; and
the processing of the first instructions is continued when the identification information is the predetermined information, and the processing of the first instructions is stopped when the identification information is not the predetermined information.

13. The instruction execution control method of claim 9, wherein,
the determining further includes:
determining whether the return instruction of the second instructions is a verification return-instruction for verifying the return address, and
determining whether the instruction at the return address includes the identification information when the return instruction of the second instructions is the verification return-instruction, and continuing the processing of the first instructions when the return instruction of the second instructions is not the verification return-instruction, without determining whether the instruction at the return address includes the identification information.

14. The instruction execution control method of claim 9, wherein,
the stopping includes causing an exception to occur when the instruction at the return address does not include the identification information.

15. The instruction execution control method of claim 9, wherein,
the determining whether an instruction at the return address includes the identification information is performed by acquiring, from a stack area for storing return addresses to which execution of code is to transition when return instructions are executed, the return address for return to the first instructions
caused by the return instruction of the second instructions.
